(19) United States
(12) Patent Application Publication
(10) Pub. No.: US 2009/0135127 A1
(43) Pub. Date: May 28, 2009

(54) DISPLAY DEVICE AND DRIVING METHOD THEREOF

(76) Inventors: Ji-Won Lee, Suwon-si (KR); Mun-Seok Kang, Suwon-si (KR)

Correspondence Address: CHRISTIE, PARKER & HALE, LLP, PO BOX 7068, PASADENA, CA, 91109-7068, US

(21) Appl. No.: 12/142,726

(22) Filed: Jun. 19, 2008

(30) Foreign Application Priority Data
Nov. 26, 2007 (KR) 10-2007-0120971

(51) Int. Cl. G09G 3/36

(52) U.S. Cl. 345/102

(57) ABSTRACT

A display device including: a panel assembly including a plurality of gate lines for transmitting a plurality of gate signals and a plurality of data lines for transmitting a plurality of data signals; a backlight unit including a plurality of scan lines for transmitting a plurality of scan signals and a plurality of column lines for transmitting a plurality of light-emitting data signals; and a signal controller configured to receive a vertical synchronization signal and to control a timing of the plurality of scan signals transmitted to the plurality of scan lines using the vertical synchronization signal.

### CROSS-REFERENCE TO RELATED APPLICATION

This application claims priority to and the benefit of Korean Patent Application No. 10-2007-0120971, filed in the Korean Intellectual Property Office on Nov. 26, 2007, the entire content of which is incorporated herein by reference.

### BACKGROUND OF THE INVENTION

1. Field of the Invention

The present invention relates to a display device. More particularly, the present invention relates to a display device having a backlight unit which operates in synchronization with a display image.

2. Description of the Related Art

Flat panel displays, such as, liquid crystal displays (LCDs), are display devices that display images by varying the amount of transmitted light per pixel using dielectric anisotropy of liquid crystal in which a twist angle varies in accordance with an applied voltage. These liquid crystal displays are advantageous due to their light-weight, small-size, and low power consumption, as compared with a cathode ray tube which is a conventional image display device.

The liquid crystal display generally includes a liquid crystal panel assembly and a backlight unit which is provided at a rear side of the liquid crystal panel assembly and supplies light to the liquid crystal panel assembly.

When the liquid crystal panel assembly is composed of an active liquid crystal panel assembly, the liquid crystal panel assembly includes a pair of transparent substrates, a liquid crystal layer interposed between the transparent substrates, polarizing plates disposed at outer surfaces of the transparent substrates, a common electrode provided on an inner surface of one of the transparent substrates, pixel electrodes and switches provided on an inner surface of the other transparent substrate, and color filters that supply red, green and blue colors to three sub-pixels forming one pixel, etc.

The liquid crystal panel assembly is supplied with light emitted from the backlight unit and transmits or blocks the light using the liquid crystal layer so as to form an image.

The above information disclosed in this Background section is only for enhancement of understanding of the background of the invention and therefore it may contain information that does not form the prior art that is already known in this country to a person of ordinary skill in the art.

### SUMMARY OF THE INVENTION

An aspect of an embodiment of the present invention provides a liquid crystal display and a driving method thereof, which reduces or prevents an image streaking phenomenon by driving a driving signal of a backlight unit in synchronization with an image to be displayed on a liquid crystal display assembly.

An embodiment of the present invention provides a display device including: a panel assembly including a plurality of gate lines for transmitting a plurality of gate signals and a plurality of data lines for transmitting a plurality of data signals; a backlight unit including a plurality of scan lines for transmitting a plurality of scan signals and a plurality of column lines for transmitting a plurality of light-emitting data signals; and a signal controller configured to receive a vertical synchronization signal and to control a timing of the plurality of scan signals transmitted to the plurality of scan lines using the vertical synchronization signal.

A time corresponding to a first result, which is obtained by dividing a first cycle of the vertical synchronization signal by a number of the plurality of scan lines, may be set as a first period, and a scan signal having a first level during the first period may be sequentially transmitted to the plurality of scan lines.

The display device may further include: a vertical synchronization signal detector for detecting the first cycle of the vertical synchronization signal; a light emitting device on-time operator for setting a time corresponding to a second result, which is obtained by dividing the first cycle by the number of the plurality of scan lines, as the first period; and a backlight unit controller for controlling the scan signal having the first level during the first period to be sequentially transmitted to the plurality of scan lines, and for controlling a plurality of light emitting data signals to be transmitted to the plurality of column lines corresponding to the scan lines to which the scan signal having the first level is transmitted.

The plurality of scan signals may be maintained at the first level during the first period.

Another embodiment of the present invention provides a method of driving a display device for transmitting a plurality of scan signals to a plurality of scan lines and for transmitting a plurality of light emitting data signals to a plurality of column lines, the method including: detecting a first synchronization period of a vertical synchronization signal; setting a time corresponding to a result obtained by dividing the first synchronization period by a number of the plurality of scan lines, as a first period; and transmitting a scan signal among the plurality of scan signals having a first level to a first scan line of the plurality of scan lines during the first period.

Transmitting of the scan signal having the first level to the first scan line may include transmitting the plurality of light emitting data signals to the plurality of column lines corresponding to the first scan line during the first period.

The display device may include: a panel assembly for transmitting a plurality of gate signals to a plurality of gate lines and for transmitting a plurality of data signals to a plurality of data lines; and a backlight unit including a scan driver for transmitting the plurality of scan signals to a plurality of scan lines and a column driver for transmitting the plurality of light emitting data signals to the plurality of column lines.

Another embodiment of the present invention provides a display device including: a panel assembly including a plurality of first pixels for receiving a plurality of gate signals and a plurality of data signals to display an image; a backlight unit including a plurality of second pixels, each of the second pixels corresponding to at least two of the first pixels, the second pixels for receiving a plurality of scan signals and a plurality of light emitting data signals to emit light corresponding to the image; a signal controller for controlling a timing of the plurality of scan signals in accordance with a vertical synchronization signal.

A time corresponding to a first result, which is obtained by dividing a first cycle of the vertical synchronization signal by a number of the plurality of scan lines, may be set as a first period, and a scan signal having a first level during the first period may be sequentially transmitted to the plurality of scan lines.

The display device may include: a timing controller comprising a panel display unit timing controller and a backlight unit timing controller.

The backlight unit timing controller may include a vertical synchronization detector, a light emitting device on-time operator, and a backlight unit controller.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is an exploded perspective view of a liquid crystal display according to an exemplary embodiment of the present invention.

FIG. 2 is a partially cut-away perspective view of the liquid crystal panel assembly shown in FIG. 1.

FIG. 3 is a partially cut-away perspective view of a backlight unit according to a first exemplary embodiment of the present invention.

FIG. 4 is a partial cross-sectional view of a fourth substrate and an electron emitting unit shown in FIG. 3.

FIG. 5 is a partial plan view of an electron emitting unit of a backlight unit according to a second exemplary embodiment of the present invention.

FIG. 6 is a partially cut-away perspective view of a backlight unit according to a third exemplary embodiment of the present invention.

FIG. 7 is a block diagram of a display device according to an exemplary embodiment of the present invention.

FIG. 8 is a block diagram of a timing controller according to an exemplary embodiment of the present invention.

FIG. 9 is a waveform diagram of a driving waveform of the backlight unit according to an exemplary embodiment of the present invention.

### DETAILED DESCRIPTION OF THE EMBODIMENTS

Backlight units are classified according to the type of light sources. A cold cathode fluorescent lamp (hereinafter, referred to as “CCFL”) has been well-known among the backlight units. The CCFL uses a line light source. Light generated from the CCFL may be regularly diffused to the liquid crystal panel assembly by an optical member, such as a diffusion sheet, a diffusion plate, or a prism sheet.

However, in the CCFL, since light generated from the CCFL is transmitted through the optical member, a large amount of light may be lost. Generally, in a liquid crystal display using the CCFL, it is known that the light transmitted through a liquid crystal panel assembly is about 3 to 5% of the light generated from the CCFL. Further, the CCFL type backlight unit needs a large amount of power, and consumes most of power consumed by the liquid crystal display. Moreover, because it is difficult to make the CCFL large due to the structure of the CCFL, the CCFL is typically not applied to a large-size liquid crystal display that has a size of 30 inches or more.

In addition, a backlight unit using a light emitting diode (hereinafter, referred to as “LED”) has been known as a backlight unit according to the related art. Generally, the LED is a point light source. A plurality of LEDs are generally provided at the same time. The LEDs are combined with optical members such as a reflective sheet, a light guide plate, a diffusion sheet, a diffusion plate, and a prism sheet so as to form the backlight unit. The backlight unit using the LEDs is advantageous due to its high response speed and excellent color reproducibility, but is disadvantageous due to its high cost and large thickness.

As described above, each of the backlight units according to the related art has problems according to the type of light source. Further, since the backlight unit according to the related art is turned on with a predetermined brightness when the liquid crystal display is driven, it is difficult to improve the image quality as required for the liquid crystal display.

For example, the liquid crystal panel assembly typically displays images having bright portions and dark portions in accordance with image signals. If the backlight unit supplies light having different intensities to the liquid crystal panel pixels for displaying the bright portions and the liquid crystal panel pixels for displaying the dark portions, respectively, it is possible to form an image having an excellent dynamic contrast.

Further, it is possible to form better dynamic images by supplying light having different intensities to the liquid crystal panel assembly using weight values corresponding to image data which can be displayed by the liquid crystal panel assembly. In addition, it is possible to reduce the power consumption which occurs in the backlight unit by reducing luminance of the entire backlight unit by using light having different intensities to which weight values are applied.

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the specification, the “connection” or “coupling” between two parts includes the “electrical connection” between the two parts with an element interposed therebetween as well as the “direct connection” therebetween. In addition, a part that includes a constituent element means that the part may further include other constituent elements rather than the part which includes only the constituent element.

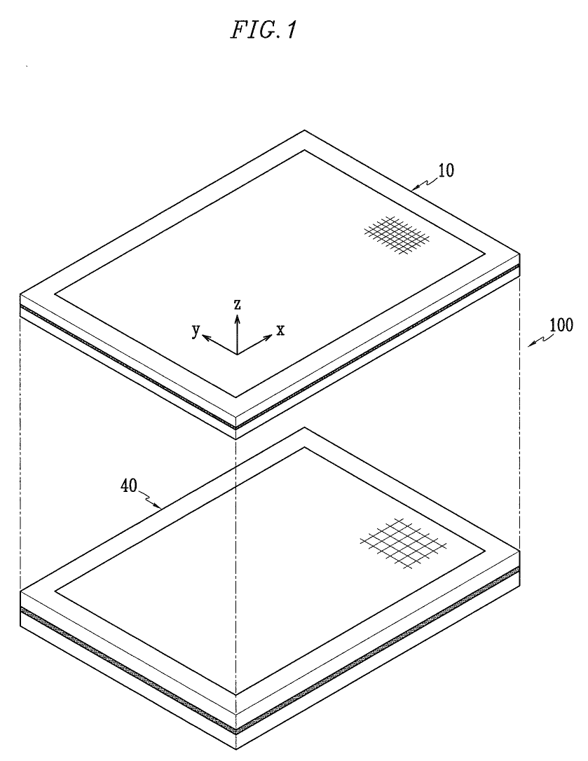

FIG. 1 is an exploded perspective view illustrating a liquid crystal display 100 according to an exemplary embodiment of the present invention.

Referring to FIG. 1, the liquid crystal display 100 includes a liquid crystal panel assembly 10 that has a plurality of pixels provided in the row direction and the column direction. A backlight unit 40 that has a plurality of pixels provided in the row direction and the column direction, is located at the rear side of the liquid crystal panel assembly 10, and supplies light to the liquid crystal panel assembly 10. The number of pixels provided in the backlight unit 40 is smaller than the number of pixels provided in the liquid crystal panel assembly 10.

Here, the row direction may be defined as one direction of the liquid crystal display 100, for example, a horizontal direction (for example, an x-axis direction of FIG. 1) of a screen formed by the liquid crystal panel assembly 10. The column direction may be defined as another direction of the liquid crystal display 100, for example, a vertical direction (for example, a y-axis direction of FIG. 1) of the screen formed by the liquid crystal panel assembly 10.

It is assumed that the number of pixels of the liquid crystal panel assembly 10 and the number of pixels of the backlight unit 40 in the row direction are represented by M and M′, respectively, and the number of pixels of the liquid crystal panel assembly 10 and the number of pixels of the backlight unit 40 in the column direction are represented by N and N′, respectively. Then, the resolution of the liquid crystal panel assembly 10 may be represented by M×N and the resolution of the backlight unit 40 may be represented by M′×N′.

In the exemplary embodiment, M and N, which represent the number of pixels of the liquid crystal panel assembly 10, may be defined by an integer equal to or greater than 240. M′ and N′, which represent the number of pixels of the backlight unit 40, may be defined by an integer in the range of 2 to 99. The backlight unit 40 includes a self-emitting display panel having the resolution of M′×N′.

Therefore, one pixel of the backlight unit 40 corresponds to two or more pixels of the liquid crystal panel assembly 10. Further, the pixels of the backlight unit 40 are controlled to be turned on/off by driving electrodes arranged in a matrix, for example, scan electrodes and data electrodes which cross each other. The intensity of light at the pixels of the backlight unit 40 is controlled by the driving electrodes.

In the present exemplary embodiment, one pixel of the backlight unit 40 includes a field emission array (FEA) type electron emission element.

The FEA type electron emission element includes a scan electrode, a data electrode, and electron emission regions and a phosphor layer which are electrically coupled to a scan electrode and a data electrode. The electron emission regions may be formed of a material which has a low work function or a high aspect ratio, for example, a carbon material or nanometer (nm) size material.

The FEA type electron emission element forms an electric field around the electron emission regions by using a voltage difference between the scan electrode and the data electrode so as to emit the electrons, and excites the phosphor layer using the emitted electrons to emit visible light of an intensity corresponding to the emission amount of the electron beam.

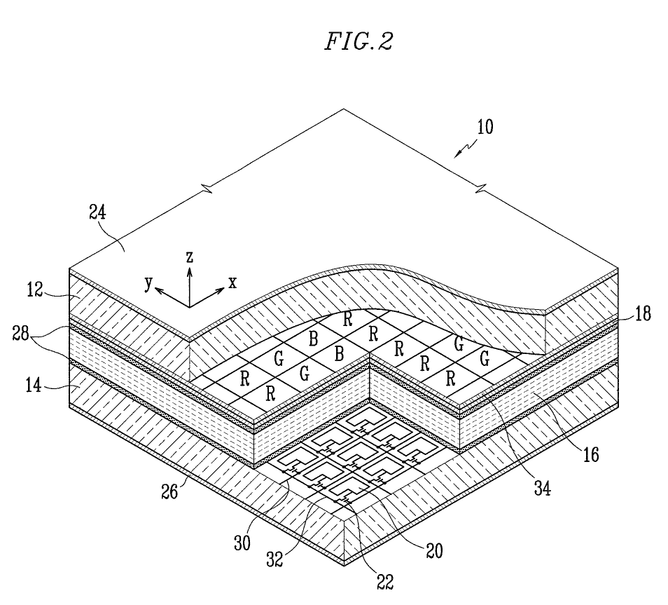

FIG. 2 is a partially cut-away perspective view of the liquid crystal panel assembly shown in FIG. 1.

Referring to FIG. 2, the liquid crystal panel assembly 10 includes a transparent first substrate 12 and a transparent second substrate 14 that are arranged to be opposite to each other, a liquid crystal layer 16 that is interposed between the first substrate 12 and the second substrate 14, a common electrode 18 provided on an inner surface of the first substrate 12, pixel electrodes 20 and switches 22 that are provided on an inner surface of the second substrate 14. A sealing member is provided at the edge of the first substrate 12 and the second substrate 14.

The first substrate 12 becomes a front substrate of the liquid crystal panel assembly 10 and the second substrate 14 becomes a rear substrate of the liquid crystal panel assembly 10. A pair of polarizing plates 24 and 26 whose polarizing axes are substantially perpendicular to each other are respectively provided on outer surfaces of the first substrate 12 and the second substrate 14. Further, an alignment film 28 covers an inner surface of the first substrate 12 where the common electrode 18 is provided, and an inner surface of the second substrate 14 where the pixel electrodes 20 and the switches 22 are provided.

A plurality of gate lines 30 that transmit a gate signal (also referred to as “scan signal”) and a plurality of data lines 32 that transmit a data signal are provided on the inner surface of the second substrate 14. The gate lines 30 are provided in parallel to the row direction and the data lines 32 are provided in parallel to the column direction.

The pixel electrodes 20 are provided for respective sub-pixels. Each sub-pixel includes a switch 22 connected to the gate line 30 and the data line 32, a liquid crystal capacitor (Clc) connected to the switch 22, and a storage capacitor (Cst). In some embodiments, the storage capacitor Cst may not be used.

The switch 22 may be formed by a thin film transistor. A control terminal and an input terminal thereof are connected to the individual gate line 30 and the individual data line 32, and an output terminal thereof is coupled to the liquid crystal capacitor Clc.

Further, a color filter 34 is disposed between the first substrate 12 and the common electrode 18. The color filter 34 includes red, green, and blue filters each corresponding to one sub-pixel. Three sub-pixels on which three filters, that is, the red, green, and blue filters are disposed, form one pixel.

In the liquid crystal panel assembly 10 that has the above-described structure, if the thin film transistor serving as the switch 22 is turned on, an electric field is generated between the pixel electrode 20 and the common electrode 18. Due to the electric field, the twist angle of the liquid crystal molecules in the liquid crystal layer 16 varies. Therefore, a color image (e.g., a predetermined color image) is formed by controlling the amount of transmitted light for every sub-pixel.

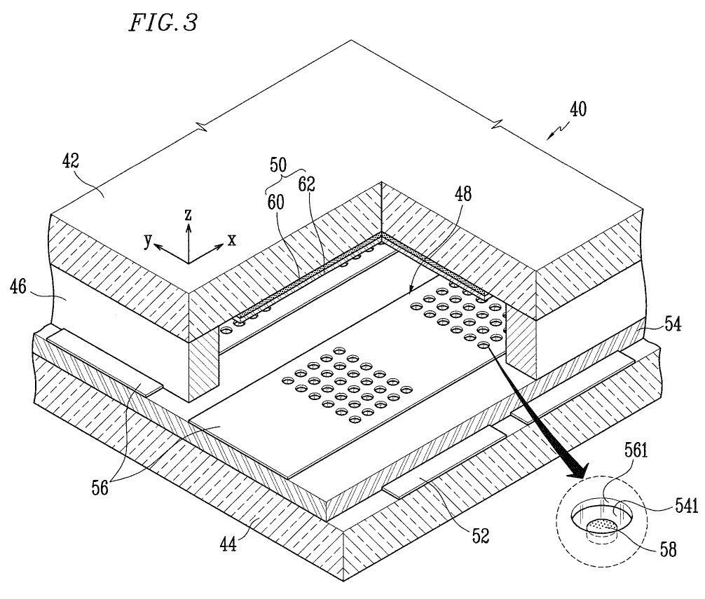

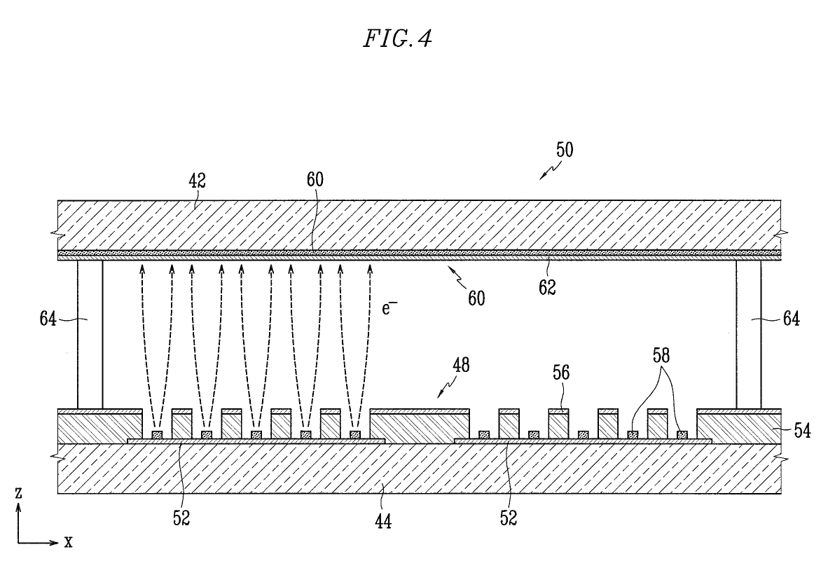

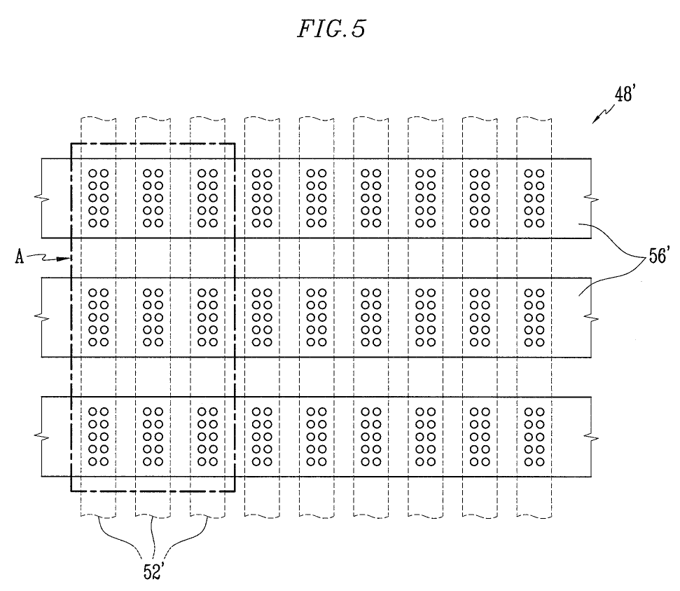

Referring to FIGS. 3 and 4, a backlight unit according to a first exemplary embodiment will be described. Referring to FIG. 5, a backlight unit according to a second exemplary embodiment will be described. The backlight unit includes an FEA type electron emission display panel which includes FEA type electron emission elements in both exemplary embodiments.

FIG. 3 is a partially cut-away perspective view of a backlight unit according to the first exemplary embodiment of the present invention and FIG. 4 is a partial cross-sectional view illustrating a fourth substrate and an electron emitting unit shown in FIG. 3.

Referring to FIGS. 3 and 4, the backlight unit 40 includes a third substrate 42 and a fourth substrate 44 that are arranged opposite to each other while being separated with a gap (e.g., a predetermined gap). A sealing member 46 is disposed at edges of the third substrate 42 and the fourth substrate 44 so as to bond the two substrates to each other. The third substrate 42, the fourth substrate 44, and the sealing member 46 form a vacuum container in which an internal space is exhausted with a vacuum ranging from about 6 to about 10 Torr (or 6 to 10 Torr).

The third substrate 42 becomes a front substrate of the backlight unit 40 facing the liquid crystal panel assembly 10 and the fourth substrate 44 becomes a rear substrate of the backlight unit 40. An electron emission unit 48 is provided on one side of the fourth substrate 44 facing the third substrate 42 so as to emit electrons. A light emitting unit 50 is provided on one side of the third substrate 42 facing the fourth substrate 44.

First, the electron emission unit 48 will be described. The electron emission unit 48 includes cathodes 52 formed in a stripe pattern along one direction of the fourth substrate 44, gate electrodes 56 formed in a stripe pattern so as to be substantially perpendicular to the cathodes 52 with the insulation layer 54 interposed therebetween, and electron emission regions 58 electrically connected to the cathodes 52.

The gate electrodes 56 may be disposed in parallel to each other in a row direction (e.g., an x-axis direction) of the fourth substrate 44 and function as the scan electrodes by being applied with the scan driving voltage. The cathodes 52 may be disposed in parallel to each other in a column direction (e.g., a y-axis direction) of the fourth substrate 44 and function as the data electrodes by being applied with the data driving voltage.

The electron emission regions 58 are formed on the cathodes 52 at regions in which the cathodes 52 and the gate electrodes 56 are perpendicular to each other. Further, a plurality of openings 541 and 561 corresponding to the electron emission regions 58 are formed in the insulation layer 54 and the gate electrodes 56, respectively, such that the electron emission regions 58 are exposed on the fourth substrate 44. In the present exemplary embodiment, the region in which the cathode 52 and the gate electrode 56 cross corresponds to one pixel region of the backlight unit 40.

The electron emission region 58 in one embodiment is formed of materials, such as carbon materials or nanometer (nm) size materials, which emit electrons when an electric field is applied in a vacuum. The electron emission regions 58 may include, for example, carbon nanotube, graphite, graphite nanofiber, diamond, diamond-like carbon, C60, silicon nanowire, or combinations thereof, and be formed by screen printing, direct growth, chemical vapor deposition, and/or sputtering.

In other embodiments, the electron emission regions may be formed of a tip structure whose front end is pointed and uses molybdenum (Mo) or silicon (Si) as main materials.

Next, the light emitting unit 50 provided below the third substrate 42 includes a phosphor layer 60 and an anode 62 provided on one side of the phosphor layer 60. The phosphor layer 60 may be formed of a white phosphor layer or may have a structure in which red, green and blue phosphor layers are combined. FIG. 3 shows the case where the phosphor layer 60 is formed of a white phosphor layer.

The white phosphor layer may be formed with respect to the entire third substrate 42 or be formed by being separated in accordance with a pattern (e.g., a predetermined pattern) such that a white phosphor layer is disposed at every pixel region. The red, green, and blue phosphor layers may be disposed in one pixel region by being separated from each other in accordance with a pattern.

The anode 62 may be formed by a metal film, such as aluminum (Al), which covers a surface of the phosphor layer 60. The anode 62 is an accelerating electrode that draws electron beams. A high voltage (e.g., thousands of DC voltages) is applied to the anode 62 to maintain the phosphor layer 60 at a high potential state and reflects visible light emitted toward the fourth substrate 44 from among visible light emitted from the phosphor layer 60 to the third substrate 42 so as to increase image luminance.

In the above-described structure, the FEA type electron emission element includes the cathode 52, the gate electrodes 56, and the electron emission regions 58. The FEA type election emission element together with the corresponding phosphor layer form one pixel.

In the above-described structure, if a driving voltage (e.g., a predetermined driving voltage) is applied to the cathodes 52 and the gate electrodes 56, an electric field is generated around the electron emission regions 58 in a pixel region where a voltage difference between the two electrodes is equal to or larger than a threshold value, thereby emitting the electrons. The emitted electrons are guided by the high voltage applied to the anode 62 and collide with the corresponding phosphor layer 60, thereby emitting light. The light emitting intensity of the phosphor layer 60 for every pixel corresponds to an electron beam emitting amount of the corresponding pixel.

FIG. 5 is a partial plan view illustrating an electron emitting unit 48′ of the backlight unit according to a second exemplary embodiment of the present invention.

Referring to FIG. 5, in the present exemplary embodiment of the invention, one pixel region A is formed by combining two or more regions where the cathodes 52′ and the gate electrodes 56′ cross. At this time, when one pixel region A is configured by combining two or more cathodes 52′ and two or more gate electrodes 56′, the two or more cathodes 52′ are electrically connected to each other and applied with the same driving voltage. Further, the two or more gate electrodes 56′ are also electrically connected to each other and applied with the same driving voltage.

In order to achieve the above, the two or more cathodes 52′ and the two or more gate electrodes 56′ are extended toward the edge of the fourth substrate 44 such that terminals mounted on a connection member, such as a flexible printed circuit board (FPCB), may be connected to each other.

FIG. 5 shows a case where, for example, nine crossing regions in which three cathodes 52′ and three gate electrodes 56′ cross form one pixel region A.

In both the backlight unit 40 according to the first exemplary embodiment and the backlight unit 40 according to the second exemplary embodiment, spacers 64 (see FIG. 4) are disposed between the third substrate 42 and the fourth substrate 44 to support a compressive force applied to the vacuum container and maintain a gap between the two substrates. The spacers 64 may be disposed at the corners of the pixel region, and not at a center of the pixel region.

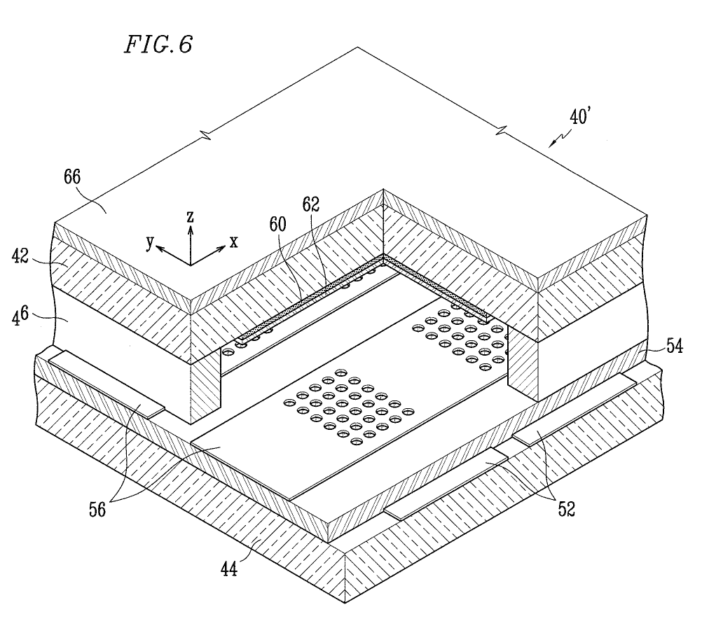

Further, in other embodiments, the third substrate 42 that is the front substrate may serve as a diffusion plate by including a light diffusion function. As shown in FIG. 6, a diffusion plate 66 that has the light diffusion function may be disposed outside (i.e., an outer surface of) the third substrate 42 facing the liquid crystal panel assembly 10.

As described above, the liquid crystal display 100 according to an exemplary embodiment of the invention uses a kind of low resolution display panel having the number of pixels smaller than that of the liquid crystal panel assembly 10 as the backlight unit 40. This backlight unit 40 is driven as a passive matrix type using scan electrodes and data electrodes, and supplies light having different intensities to the pixels of the liquid crystal panel assembly 10.

A table below shows numbers of pixels of the backlight unit 40 according to the resolution of the liquid crystal panel assembly 10. The number of pixels is determined by testing the display quality, a manufacturing cost of the driving circuit unit, and ease of manufacturing the driving circuit unit, while changing the number of pixels of the backlight unit 40 with respect to the liquid crystal panel assembly 10 having a resolution (e.g., a predetermined resolution).

TABLE 1

| | | | The number of |
|---|---|---|---|
| | | | pixels in liquid |
| | The number of | | crystal panel |
| Resolution of liquid | pixels in liquid | The number of | assembly)/(the |
| crystal panel | crystal panel | pixels in | number of pixels |
| assembly (M × N) | assembly | backlight unit | in backlight unit) |
| 320 × 240 | 76,800 | 25 to 300 | 256 to 3,072 |
| 640 × 400 | 256,000 | 100 to 1,000 | 256 to 2,560 |
| 640 × 480 | 307,200 | 100 to 1,200 | 256 to 3,072 |
| 800 × 480 | 384,000 | 160 to 1,500 | 256 to 2,400 |
| 800 × 600 | 480,000 | 256 to 2,000 | 240 to 1,875 |
| 1024 × 600 | 614,400 | 144 to 640 | 960 to 4,270 |
| 1024 × 768 | 786,432 | 144 to 768 | 1,024 to 5,464 |
| 1280 × 768 | 983,040 | 192 to 960 | 1,024 to 5,120 |
| 1280 × 1024 | 1,310,720 | 256 to 1,280 | 1,024 to 5,120 |
| 1366 × 798 | 1,090,068 | 256 to 1,344 | 812 to 4,260 |
| 1400 × 1050 | 1,470,000 | 320 to 1,728 | 852 to 4,600 |
| 1600 × 1200 | 1,920,000 | 400 to 2,000 | 950 to 4,800 |
| 1920 × 1200 | 2,304,000 | 400 to 2,400 | 960 to 5,760 |
| 2048 × 1536 | 3,145,728 | 576 to 3,072 | 1,024 to 5,462 |
| 2560 × 2048 | 5,242,000 | 896 to 5,120 | 1,024 to 5,852 |
| 3200 × 2400 | 7,680,000 | 1,440 to 7,500 | 1,024 to 5,334 |

On the basis of the above-describe result, it can be understood that the value of (the number of pixels in liquid crystal panel assembly)/(the number of pixels in backlight unit) in one embodiment is preferably in the range of 240 to 5,852. In this embodiment, if the value is larger than 5,852, it may be difficult to improve a dynamic contrast ratio using the backlight unit. Further, in this embodiment, if the value is smaller than 240, it may be difficult to manufacture and drive the backlight unit, thereby causing the manufacturing cost to increase. In other embodiments, the ratio may be smaller than 240 or larger than 5,852.

Further, according to an exemplary embodiment of the invention, one pixel of the backlight unit 40 may have a size in the range of 2 to 50 mm in the row direction and/or column direction. If the pixel size in the row direction and/or column direction is smaller than 2 mm, the backlight unit 40 has a large number of pixels. Therefore, it is difficult to process circuit signals. If the pixel size in the row direction and/or column direction is larger than 50 mm, the backlight unit 40 does not have enough pixels. Therefore, the effect of improving the image quality with the backlight unit 40 is not noticeable.

As such, since the liquid crystal display 100 according to an exemplary embodiment of the invention uses the backlight unit 40 having the above-described structure, it may have better performance as compared with the backlight unit using the cold cathode fluorescent lamp (hereinafter, referred to as “CCFL”) and the light emitting diode (hereinafter, referred to as “LED”) according to the related art.

The backlight unit 40 according to an exemplary embodiment of the invention is a surface light source. Therefore, the backlight unit 40 does not need a plurality of optical members, as used in the backlight units using the CCFL or LED. Accordingly, in the backlight unit 40 according to an exemplary embodiment of the invention, there is reduced or minimal light loss which occurs when the light passes through the optical member and there is no need to emit light having excessive intensity from the backlight unit 40 due to the low light loss, resulting in excellent efficiency with low power consumption.

Further, the power consumption of the backlight unit 40 according to an exemplary embodiment of the invention is lower than that of the backlight unit using the CCFL, and the backlight unit 40 according to an exemplary embodiment of the invention does not use the optical member, which decreases the manufacturing cost. Further, the thickness of the backlight unit 40 according to an exemplary embodiment of the invention can be further decreased, as compared with the backlight unit using the LED. Furthermore, the size of the backlight unit 40 according to an exemplary embodiment of the invention can be easily made large and thus easily applied to a large size liquid crystal display whose size is 30 inches or more.

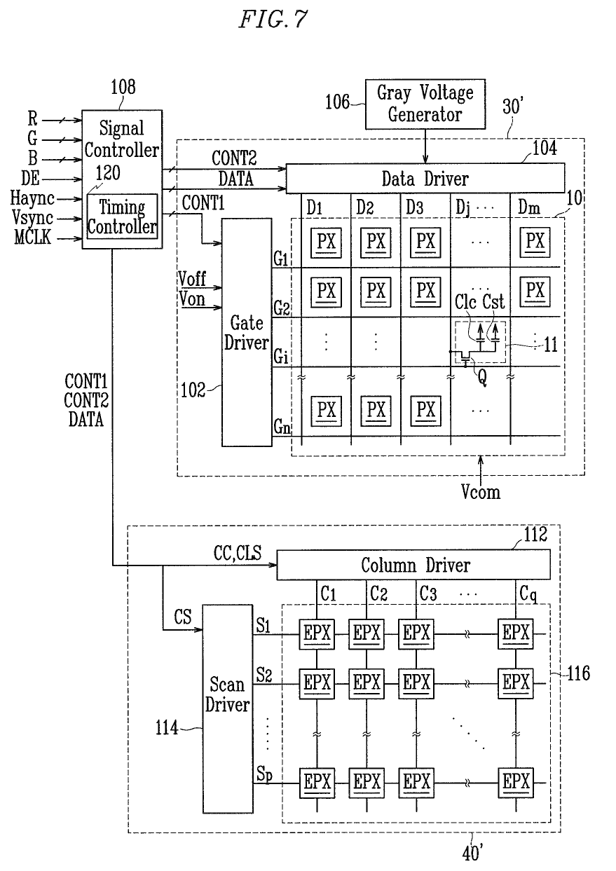

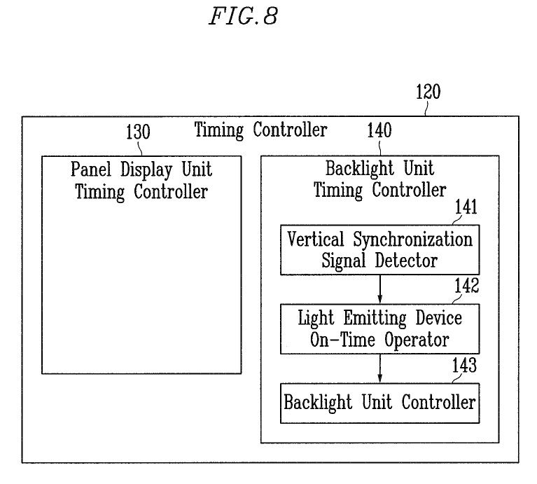

FIG. 7 is a block diagram of a display device according to an exemplary embodiment of the present invention. FIG. 8 is a block diagram of a timing controller according to an exemplary embodiment of the present invention.

The display device according to another exemplary embodiment of the present invention is a light receiving element and includes a liquid crystal panel assembly using liquid crystal elements. However, the present invention is not limited thereto.

As shown in FIG. 7, the display device according to an exemplary embodiment of the present invention includes a panel display unit 30′, a gray voltage generator 106, a backlight unit 40′, and a signal controller 108 which controls the above-described components. The panel display unit 30′ includes a liquid crystal panel assembly 10, and a gate driver 102 and a data driver 104 which are connected to the liquid crystal panel assembly 10. Further, the panel display unit 30′ is connected to the gray voltage generator 106.

The liquid crystal panel assembly 10 includes a plurality of signal lines G1 to Gn and D1 to Dm, and a plurality of pixels PX coupled to the plurality of signal lines G1 to Gn and D1 to Dm that are arranged in a matrix. The signal lines G1 to Gn and D1 to Dm include the plurality of gate lines G1 to Gn that transmit the gate signals (or “scan signal”) and the plurality of data lines D1 to Dm that transmit data signals.

Each pixel PX, for example, a pixel 11 connected to an i-th (where i=1, 2, . . . and n) gate line Gi and a j-th (where j=1, 2, . . . , and m) data line Dj, includes a switch Q connected to the signal lines Gi and Dj, a liquid crystal capacitor Clc connected to the switch Q, and a storage capacitor Cst. The storage capacitor Cst may be omitted in other embodiments.

The switch Q is a three terminal element such as a thin film transistor that is provided on a lower substrate (e.g., similar to the second substrate of 14 of FIG. 2). A control terminal of the switch Q is coupled to the gate line Gi, an input terminal of the switch Q is coupled to a data line Dj, and an output terminal of the switch Q is coupled to the liquid crystal capacitor Clc and the storage capacitor Cst.

The gray voltage generator 106 generates two sets of gray voltages (or sets of reference gray voltages) associated with the transmittance of the pixel PX. One of two sets of gray voltages has a positive value with respect to the common voltage Vcom, and the other has a negative value with respect to the common voltage Vcom.

The gate driver 102 is coupled to the gate lines G1 to Gn of the liquid crystal panel assembly 10 and applies a gate signal obtained by combining a gate-on voltage Von and a gate-off voltage Voff to the gate lines G1 to Gn.

The data driver 104 is coupled to the data lines D1 to Dm of the liquid crystal panel assembly 10, selects a gray voltage from the gray voltage generator 106, and applies the gray voltage to the data lines D1 to Dm as the data signal. However, when the gray voltage generator 106 does not supply the voltages with respect to all of the grayscale levels but supplies a number (e.g., a predetermined number) of reference gray voltages, the data driver 104 divides the reference gray voltage so as to generate the gray voltages with respect to the entire grayscale levels and selects a data signal therefrom.

The signal controller 108 includes a timing controller 120 and controls the panel display unit 30′ and the backlight unit 40′. The signal controller 108 controls the gate driver 102, the data driver 104, and the column driver 112 and the scan driver 114. The signal controller 108 receives input image signals R, G, and B and input control signals for controlling the display of the image signals from an external graphic controller.

The input image signals R, G, and B have luminance information for each pixel PX, and the luminance information has a number (e.g., a predetermined number) of gray levels, for example, 1024 (=2¹⁰), 256 (=2⁸), or 64 (=2⁶). Examples of the input control signals include a vertical synchronizing signal Vsync, a horizontal synchronizing signal Hsync, a main clock MCLK, and a data enable signal DE. One frame of the liquid crystal panel assembly 10 can be scanned during one cycle T1 of the vertical synchronization signal Vsync. The one cycle T1 of the vertical synchronization signal Vsync is used to match a driving synchronization between the panel display unit 30′ and the backlight unit 40′.

The timing controller 120 includes a panel display unit timing controller 130, and a backlight unit timing controller 140. Further, the timing controller 120 controls a driving signal of the panel display unit 30′ and the backlight unit 40′ such that the backlight unit 40′ operates in synchronization with an image displayed on the panel display unit 30′.

The panel display unit timing controller 130 appropriately processes the input image signals R, G, and B according to the operation conditions of the liquid crystal panel assembly 10 on the basis of the input control signals, and generates a gate control signal CONT1 and a data control signal CONT2. Then, the signal controller 108 transmits the gate control signal CONT1 to the gate driver 102, and transmits the data control signal CONT2 and the processed image signals DATA to the data driver 104. According to an exemplary embodiment of the present invention, the gate control signal CONT1 has the same cycle as the horizontal synchronization signal Hsync. A gate-on voltage is sequentially applied to each of the gate lines G1 to Gn during one cycle of the gate control signal CONT1. The data control signal CONT2 includes a line clock and a data signal corresponding to the gate lines G1 to Gn, to which the gate-on voltage is applied and is synchronized with a rising edge timing of the line clock to be transmitted to the data lines D1 to Dm.

The backlight unit timing controller 140 includes a vertical synchronization signal detector 141, a light emitting device on-time operator 142, and a backlight unit controller 143. Further, the backlight unit timing controller 140 generates a scan driving control signal CS using the vertical synchronization signal Vsync. According to an exemplary embodiment of the present invention, the scan driving control signal CS, which includes an on-time control signal CLK, is generated in synchronization with the vertical synchronization signal Vsync. Further, the backlight unit timing controller 140 generates a light emission control signal CC using the scan driving control signal CS. According to an exemplary embodiment of the present invention, the light emission control signal CC includes a light emitting data transmitting signal DCLK and has a first period T3 which is the same as that of the on-time control signal CLK. Further, in the first period T3 of the light emitting data transmitting signal DCLK, a plurality of light emitting data signals are transmitted to a plurality of column lines C1 to Cq during a high level maintaining period. Further, the backlight unit timing controller 140 generates a light emitting signal CLS using the image signal DATA with respect to the plurality of liquid crystal pixels PX corresponding to one pixel EPX of the backlight unit 40′ and transmits the generated light emitting signal CLS to the column driver 112 and the scan driver 114.

In particular, the vertical synchronization signal detector 141 detects one cycle T1 of the vertical synchronization signal Vsync to be transmitted to the panel display unit 30′ and transmits the detected one cycle T1 to the light emitting device on-time operator 142. Then, the light emitting device on-time operator 142 divides one cycle T1 of the vertical synchronization signal Vsync by the number of scan lines S1 to Sp connected to the scan driver 114 so as to generate the on-time control signal CLK. The on-time control signal CLK has a time corresponding to the result obtained by dividing the one cycle T1 of the vertical synchronization signal Vsync by the number of scan lines S1 to Sp as one cycle T2. In addition, the light emitting device on-time operator 142 transmits the on-time control signal CLK generated according to the number of scan lines S1 to Sp to the backlight unit controller 143. According to an exemplary embodiment of the present invention, the vertical synchronization signal detector 141 and the light emitting device on-time operator 142 generate the on-time control signal CLK using the vertical synchronization signal Vsync. However, the present invention is not limited thereto and can use another synchronization signal according to the user selection.

The backlight unit controller 143 transmits the on-time control signal CLK to the scan driver 114 and transmits the light emitting data transmitting signal DCLK to the column driver 112. Using an image signal DATA with respect to the plurality of liquid crystal pixels PX corresponding to one pixel EPX of the backlight unit 40′, the backlight unit controller 143 detects the highest grayscale level of the plurality of pixels PX corresponding to one pixel EPX of the backlight unit 40′ and calculates the first grayscale level of the backlight unit pixels EPX corresponding to the detected grayscale level. Then, the backlight unit controller 143 converts the calculated first grayscale level into digital data and transmits a light emitting signal CLS to the column driver 112. According to an exemplary embodiment of the present invention, the light emitting signal CLS includes 6 bit or more digital data having 6 bits or more according to the grayscale level of the backlight unit pixels EPX.

The backlight unit 40′ includes a column driver 112, a scan driver 114, and a display section 116.

A display section 116 includes a plurality of scan lines S1 to Sp that transmit scan signals, a plurality of column lines C1 to Cq that transmit column signals, and a plurality of light emitting pixels EPX. The plurality of light emitting pixels EPX are provided in a region where the scan lines S1 to Sp cross the column lines C1 to Cq. The scan lines S1 to Sp are coupled to the scan driver 114 and the column lines C1 to Cq are coupled to the column driver 112. The scan driver 114 and the column driver 112 are coupled to the backlight unit controller 143 and operate according to a control signal of the backlight unit controller 143.

The plurality of scan lines S1 to Sp are scan electrodes of the above-described backlight unit 40′ and the column lines C1 to Cq are data electrodes of the above-described backlight unit 40′. The light emitting pixels EPX are formed by the FEA type electron emission elements.

The scan driver 114 is connected to the plurality of scan lines S1 to Sp and transmits a scan signal to the gate electrodes such that each of the backlight unit pixels EPX may emit light in synchronization with the plurality of liquid crystal pixels PX corresponding to each of the backlight unit pixels EPX according to the scan driving control signal CS.

The column driver 112 is connected to the plurality of column lines C1 to Cq and controls each of the backlight unit pixels EPX such that the backlight unit pixels EPX may emit light in synchronization with grayscale levels of the plurality of liquid crystal pixels PX corresponding to each of the backlight unit pixels EPX according to the light emission control signal CC and the light emitting signal CLS.

The column driver 112 generates a plurality of light emitting data signals according to the light emitting signal CLS and transmits the generated light emitting data signals to the plurality of column lines C1 to Cq according to the light emission control signal CC.

That is, the column driver 112 synchronizes the light emitting pixels EPX to emit light at a grayscale level (e.g., a predetermined grayscale level) in accordance with an image to be displayed on a plurality of liquid crystal pixels PX corresponding to one backlight unit pixel EPX.

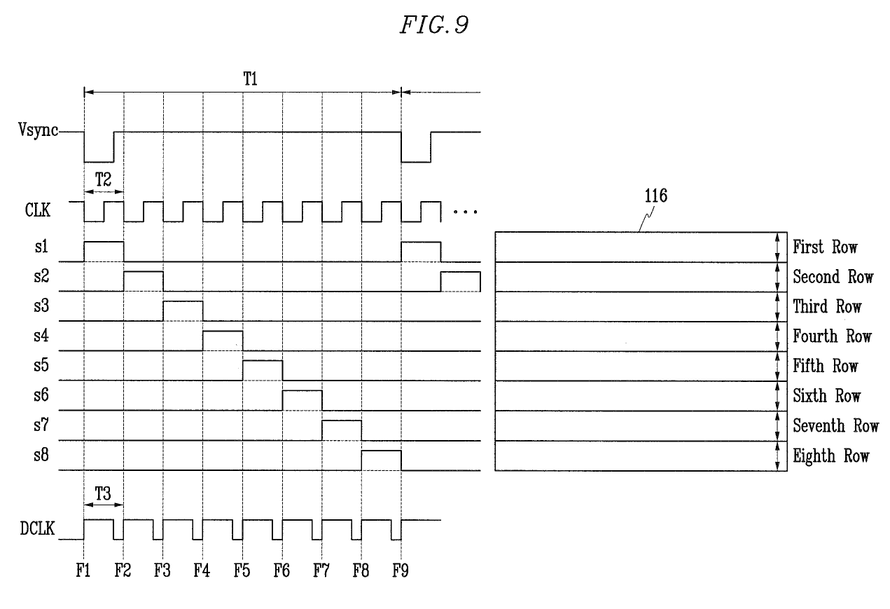

Hereinafter, referring to FIG. 9, the operation of the backlight unit 40′ according to an exemplary embodiment of the present invention will be described in detail.

FIG. 9 is a waveform diagram illustrating the vertical synchronization signal Vsync, the on-time control signal CLK, the scan signal s1 to s8, and the light emitting data transmitting signal DCLK. For convenience of description, only 8 scan signals are shown, however, there may be more or fewer scan signals.

As shown in FIG. 9, the on-time control signal CLK is generated in synchronization with the vertical synchronization signal Vsync and the scan signals s1 to s8 are maintained at a first level during one cycle T2 of the on-time control signal CLK.

Specifically, the backlight unit timing controller 140 detects one cycle T1 of the vertical synchronization signal Vsync to generate the on-time control signal CLK, and transmits the generated on-time control signal CLK to the scan driver 114. Further, the backlight unit timing controller 140 transmits the light emitting data transmitting signal DCLK to the column driver 112. Then, the scan driver 114 sequentially maintains the scan signals s1 to sp of the respective scan lines S1 to Sp at the first level during one cycle T2 of the on-time control signal CLK. At this time, the column driver 112 transmits the plurality of light emitting data signals to the plurality of column lines C1 to Cq. Further, the column driver 112 transmits the plurality of light emitting data signals according to the light emitting data transmitting signal DCLK. Specifically, the column driver 112 transmits the plurality of light emitting data signals to the plurality of column lines C1 to Cq when a high level is maintained in one cycle T3 of the light emitting data transmitting signal DCLK. That is, the plurality of backlight unit pixels EPX included in the scan lines corresponding to the scan signals at the first level from among the scan signals s1 to sp of the plurality of scan lines S1 to Sp emit light so as to correspond to the plurality of light emitting data signals.

For example, the scan driver 114 transmits the scan signal s1 having the first level to the scan line S1 during one cycle T2 at which a falling edge timing F1 of the on-time control signal CLK is generated. At this time, the column driver 112 transmits the plurality of light emitting data signals to the plurality of column lines C1 to Cq when a high level is maintained during the one cycle T3 of the light emitting data transmitting signal DCLK. Then, the plurality of backlight unit pixels EPX at the first row of the display section 116 emit light according to the plurality of light emitting data signals.

Further, the scan driver 114 transmits the scan signal s2 having the first level to the scan line S2 during one cycle T2 at which a falling edge timing F2 of a next on-time control signal CLK is generated. At this time, the scan line S1 is held by the scan signal s2 having a second level. Meanwhile, the column driver 112 transmits the plurality of light emitting data signals to the plurality of column lines C1 to Cq when a high level is maintained during the one cycle T3 of the light emitting data transmitting signal DCLK. Then, the plurality of backlight unit pixels EPX at the second row of the display section 116 emit light according to the plurality of light emitting data signals.

In a same manner, the scan signals s3 to s8 having the first level are sequentially transmitted to the plurality of scan lines S3 to S8.

Then, the backlight unit pixels EPX corresponding to the third to eighth rows of the display section 116 emit light according to the plurality of light emitting data signals. According to an exemplary embodiment of the present invention, the first level is a high level and the second level is a low level.

As described above, according to the third exemplary embodiment of the present invention, the backlight unit 40′ emits light according to the on-time control signal CLK generated in synchronization with the vertical synchronization signal Vsync. Therefore, it is possible to prevent or reduce an image streaking phenomenon in an image, which may occur when the driving signal of the panel display unit 30′ is not synchronized with the driving signal of the backlight unit 40′.

The display device using the liquid crystal panel assembly according to an exemplary embodiment has been described. However, the present invention is not limited thereto. The present invention may be applied to a display device which receives light from a backlight unit to display an image as well as a self-emitting display device.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims.

As described above, the display device and the driving method thereof according to an exemplary embodiment of the present invention can prevent or reduce the image streaking phenomenon which occurs due to a difference in the amount of light transmitted through the panel assembly by synchronizing the backlight unit with an image to be displayed on the panel assembly.

What is claimed is:

1. A display device comprising:
a panel assembly comprising a plurality of gate lines for transmitting a plurality of gate signals and a plurality of data lines for transmitting a plurality of data signals;
a backlight unit comprising a plurality of scan lines for transmitting a plurality of scan signals and a plurality of column lines for transmitting a plurality of light-emitting data signals; and
a signal controller configured to receive a vertical synchronization signal and to control a timing of the plurality of scan signals transmitted to the plurality of scan lines using the vertical synchronization signal.

2. The display device of claim 1,
wherein a time corresponding to a first result, which is obtained by dividing a first cycle of the vertical synchronization signal by a number of the plurality of scan lines, is set as a first period, and
wherein a scan signal having a first level during the first period is sequentially transmitted to the plurality of scan lines.

3. The display device of claim 2, further comprising:
a vertical synchronization signal detector for detecting the first cycle of the vertical synchronization signal;
a light emitting device on-time operator for setting a time corresponding to a second result, which is obtained by dividing the first cycle by the number of the plurality of scan lines, as the first period; and
a backlight unit controller for controlling the scan signal having the first level during the first period to be sequentially transmitted to the plurality of scan lines, and for controlling a plurality of light emitting data signals to be transmitted to the plurality of column lines corresponding to the scan lines to which the scan signal having the first level is transmitted.

4. The display device of claim 1, wherein the plurality of scan signals are maintained at the first level during the first period.

5. A method of driving a display device for transmitting a plurality of scan signals to a plurality of scan lines and for transmitting a plurality of light emitting data signals to a plurality of column lines, the method comprising:
detecting a first synchronization period of a vertical synchronization signal;
setting a time corresponding to a result obtained by dividing the first synchronization period by a number of the plurality of scan lines, as a first period; and
transmitting a scan signal among the plurality of scan signals having a first level to a first scan line of the plurality of scan lines during the first period.

6. The method of claim 5, wherein transmitting of the scan signal having the first level to the first scan line comprises transmitting the plurality of light emitting data signals to the plurality of column lines corresponding to the first scan line during the first period.

7. The method of claim 6, wherein the display device comprises:
a panel assembly for transmitting a plurality of gate signals to a plurality of gate lines and for transmitting a plurality of data signals to a plurality of data lines; and
a backlight unit comprising a scan driver for transmitting the plurality of scan signals to a plurality of scan lines and a column driver for transmitting the plurality of light emitting data signals to the plurality of column lines.

8. A display device comprising:
a panel assembly comprising a plurality of first pixels for receiving a plurality of gate signals and a plurality of data signals to display an image;
a backlight unit comprising a plurality of second pixels, each of the second pixels corresponding to at least two of the first pixels, the second pixels for receiving a plurality of scan signals and a plurality of light emitting data signals to emit light corresponding to the image;
a signal controller for controlling a timing of the plurality of scan signals in accordance with a vertical synchronization signal.

9. The display device of claim 8,
wherein a time corresponding to a first result, which is obtained by dividing a first cycle of the vertical synchronization signal by a number of the plurality of scan lines, is set as a first period, and
wherein a scan signal having a first level during the first period is sequentially transmitted to the plurality of scan lines.

10. The display device of claim 8, further comprising:
a timing controller comprising a panel display unit timing controller and a backlight unit timing controller.

11. The display device of claim 10, wherein the backlight unit timing controller comprises a vertical synchronization detector, a light emitting device on-time operator, and a backlight unit controller.
